(19) United States
(12) Patent Application Publication
(10) Pub. No.: US 2004/0034567 A1
(43) Pub. Date: Feb. 19, 2004

(54) On-line transactions and system therefore

(76) Inventors: Antony Hugh Gravett, Craryville, NY (US); Kelly Wypych, Syracuse, NY (US)

Correspondence Address: William H. Saltzman, 30 East 65th Street, New York, NY, 10021, US

(21) Appl. No.: 10/002,841

(22) Filed: Nov. 28, 2001

(51) Int. Cl. G06F 17/60

(52) U.S. Cl. 705/26

(57) ABSTRACT

This invention relates to and has as its object a method for conducting dynamic on-line purchasing transactions whereby a customer can dynamically interact with a number of vendors to initiate and complete a purchase transaction on-line in a single continuous operation, and systems useful for such purposes.

This invention is a continuation application of Provisional Application Serial No. 60/250549, filed Dec. 1, 2000.

This invention relates to and has as its objective a method of conducting and completing multiparty and interactive commercial transactions electronically, and systems useful in the practice thereof More specifically, the transactions of the sort included within the scope of this invention may be such transactions that occur while connected to an electronic network, such as the Internet; for example, e-commerce transactions, such as the on-line purchase of goods and services; purchase and/or downloading of software; searching the World Wide Web based on particular key words; electronic banking and brokerage transactions; and other like operations and transactions that require multiple, multiparty, and interactive transaction steps to complete.

As presently conducted the electronic transactions contemplated by this invention are inefficient and cannot be conducted in a single seamless transaction from beginning to end. Prior to the present invention, a customer seeking to purchase goods or services electronically had had to engage in a number of cumbersome processes, involving multiple screens and steps that must be repeated for each desired transaction and each potential supplier, especially if such goods or services were sought to be purchased from among multiple vendors. Another problem has been that an overabundance of was or had to be transmitted to both the vendor and the customer, thus cluttering the screen with unnecessary data, which not only caused inordinate delays in the completion of any transaction, but required the disclosure of excess information to potential vendors thus jeopardizing the privacy of the customer. Furthermore, under present practice, once the customer initiates the on-line purchase process, completion of the transaction, i.e. actual delivery to the customer, requires that several electronic communications between be sent and responded to by the customer to confirm the order, the shipment of, the payment for, and the delivery of the goods or services required. A further problem with the existing processes employed for e-commerce transactions involves the need for the customer to contact and interface with each of a number of vendors at each of their websites in order to purchase from a single vendor offering the best terms and conditions to the customer. This involves the necessity for the customer to provide his purchase information to each vendor for a single purchase. This is a time consuming and essentially risky procedure in that the customer's confidential data may be widely disseminated to a number of parties, increasing the possibility of its misuse by unauthorized persons.

In the situation where a customer wishes to purchase a particular product or service on-line and wishes to specify preferences describing his preferred choice, there is presently no method for the customer to statically create and publish this need or requirement such that vendors can respond to this need in a coherent way using a feedback mechanism. Further, there is currently no mechanism that allows the customer to publish his needs anonymously while still allowing easy access to consolidated vendor responses providing. Until the instant invention, a customer needed to either view various websites, make multiple contacts and make such comparisons manually, or visit websites that consolidate vendor information based on products and services or model numbers, etc. Until this invention, the customer needed to go on-line and take the initiative and actions to conduct these efforts and there was no way for this to occur in response to a static request entered on the user's computing device.

It is novel that the instant invention provides for communication between the customer and any number of vendors without disclosing the customer's identity or personal information, such as phone number, name, e-mail address, and other confidential information. The customer is identified uniquely by the TSM such that all vendor responses are directed back to the customer correctly, without disclosure of any customer information to the vendor, absent the express consent of the customer. Such customer express consent can be given in exchange for some extra consideration from the vendor, if desired.

Therefore, at present, it is not possible for a customer, using e-commerce means, to initiate a purchase transaction for goods or services, among a number of potential, competing vendors to get the most desired terms and conditions, without the customer having to initiate such transactions on vendor websites. The present invention obviates all of the foregoing problems attendant to on-line purchasing and allows the customer to publish his product/service needs and purchase request thereby inviting such responses that will meet his requirements (as opposed to needing to search or seek to fulfill such needs); have this request transmitted to a number of potential vendors; receive consolidated competing offers from a number of vendors; make a selection from among these multiple offers to purchase said item; and be able to complete the said purchase by paying for and having said purchase delivered in a single, seamless electronic transaction.

### DESCRIPTION OF THE INVENTION

The instant invention is directed to a method of making and completing on-line purchase transactions involving a number of potential vendors in a simple, efficient and useful manner, and employing novel systems developed for such purpose. This invention allows a customer to initiate and complete an on-line transaction with one or a number of potential vendors employing a novel system which allows said transaction to be completed in an efficient and seamless manner. More particularly, this invention involves a novel system comprised of at least 3 essential functional and interdependent elements. These elements are comprised of the following discrete entities:

1. A Customer Platform (hereinafter referred to as “CP”); and

2. A Transaction Server Means (hereinafter referred to as “TSM”); and

3. A Vendor Platform (hereinafter referred to as “VP”).

Generally speaking, the CP which initiates the desired transaction, is interactively connected to the VP, which provides the desired product or service to the CP, by the TSM, which interconnects and dynamically interacts with and controls the progress and completion of the desired e-transaction to its conclusion in a seamless, efficient process. More particularly, the CP is usually comprised of a computing device, such as a personal computer in which is stored all necessary data and software required to allow the customer to initiate, monitor and complete therethrough, all the actions needed to complete the required e-transaction. The computer device and software employed in the practice of this invention by the customer must also be capable of providing and administering Dynamic Transaction Objects (as hereinafter described and referred to as a “DTO”). For a customer to create a DTO it is necessary that the customer's computer device be running on software which is compatible and responsive to the TSM (as hereinafter described). Examples of such software or operating systems include, Microsoft Windows (TM), Palm OS (TM), MacOS (TM), Unix(TM), Linux(TM), and other systems designed for computing and communications devices that are comprised of a set of instructions that allow the device used to run various software code sets (such as the CP), or software that can be used or configured to conduct transactions with other computing devices such as internet servers and the like. It is recognized that computer operating systems and platforms are rapidly evolving, and the skilled worker will will be cognizant that the specific software or operating systems used on the devices employed herein may change from time to time.

The TSM has an internal means of connecting to, communicating and interacting with both the CP and VP, to form a single network through which communications and data are interchanged when an e-transaction is initiated and processed to completion.

The computer device employed in connection with the CP must be capable of running an operating system able to support the CP functions, code and activities that create and display multifunctional graphical icons or other graphical elements on the computer screen. These multifunctional graphical icons or elements are capable of being “clicked on” or selected on the computer screen by a mouse or other pointing/selecting device, or it may be a multifunctional graphical icon employed in the Palm OS or such other system; provided that a graphical user interface, such as Windows, MacOS, Linux, Unix,PalmOS, etc., is employed. The customer's computer device will have installed therein software which will allow it to communicate and interact with the TSM to create, modify, display and update the multifunctional graphical icons which are employed to initiate and complete the desired on-line transaction, and which comprise the DTOs of this invention.

At present, each on-line e-transaction performed in the practice of the instant invention, is actually a series of complex transactional steps that must be taken by both the customer and vendor, and having to perform each of these steps for each transaction is time consuming, confusing and in many instances, inaccurate, In the practice of the instant invention each e-transaction or potential e-transaction, is initiated by opening a multifunctional graphical icon or DTO, on the customers computer screen. The multifunctional graphic icon shows up on the customer's computer screen as an isometric representation of the product or service sought to be purchased by the customer. For instance, if the customer is seeking to purchase a book, a generic book graphical icon is shown in a three dimensional form, with protruding properties or tabs, as will be further specifically described. If desired, after a book matching the customer's request is located at a VP, a more descriptive icon can be substituted or added to the original DTO, for example, a representation of the cover or title of the book. In the event the customer desires to purchase more than one of the same generic products, e.g. a number of books, multiple DTO,s one for each such additional item, can be stacked one upon another, while the customer still has access to the properties or tabs of each DTO, as each of these continue to protrude from the stacked DTOs. It is also possible to temporarily move a DTO to the foreground by moving the computer mouse or pointing device over a preassigned sensitive, or “hot spot” on the DTO, thereby making it fully viewable and editable. Moving the mouse away from said “hot spot” causes the DTO to return to its previous position in the stack of DTOs.

In addition to the foregoing, each DTO icon has a number of properties or active sites for the initiation of part of the e-transaction process. For example, there may be a tab on the DTO icon for initiating the search for the product or service sought to be purchased; a tab for determining the current status of an ongoing transaction; a tab which can be activated for the purposes of inputting additional or different information to alter the transaction in progress; a tab for the entry of the purchase order; and other additional tab sites. These properties or tabs are activated by the customer clicking thereon, which will bring up on the customer's screen the appropriate prompt or graphic for which the property or tab is being used.

The TSM is a computer or data and information retriever and exchanger of the internet service provider (hereinafter “ISP”), which is the foundation of the system being employed in the instant invention. The TSM serves as the interactive intermediary between the CP and the VP of this invention. Once the transaction is initiated by a customer using the CP to access the TSM, i.e. the internet service provider, after validation of the CP, the appropriate DTOs covering the products and/or services previously selected by the customer and representing initiated transactions, appear on the customer's computer screen. In addition, the TSM provides a listing of products and services which are available through the instant system and from which the customer may create new DTOs to initiate new transactions. These new DTOs may then be activated as selected by the customer clicking thereon and inputting the required information and data as requested by the TSM pursuant to the programs installed therein. For example, if the customer clicks on the “book” purchase icon to initiate the purchase of a book, the TSM will respond by opening a window on the customer's screen which requests the necessary information to identify the book requested, e.g. author, title, publication date, etc., which when completed will be transmitted to the TSM where a l)TO will be created and stored in the DTO storage bank, and simultaneously displayed on the customer's screen. Once this information is transmitted to the TSM and the DTO is created, the customer can disconnect from the TSM and progress will still continue to be made by the TSM on the desired transaction. The TSMK which has stored on its central computer means the customer's DTOs, initiates and continues the transaction by transmitting the customer's purchase request to all those participants in the VP which are capable of supplying such products. The TSM is also capable of contacting non-VP participants, such as vendors capable of supplying the specified product or service and invites them to become VP participants by alerting them to a specific potential customer purchase or other customer need. Those participating VPs will receive the customer's request, review same and will respond to the TSM with their offer to supply the requested product, and the TSM will then transfer the essential data to the customer's DTO, which when pulled up by the customer will provide the responses submitted.

Thus, the customer can allow an interval of minutes, days or even weeks to go by before reconnecting to the TSM and then receiving the updated DTOs. None of the DTOs previously created will have disappeared during the time the customer is not connected; their state may have changed however, due to progress having been made on the transaction in the interim. Upon reconnection, the customer receives all updates which are then reflected in the customer's computer display of the respective DTOs. In this sense, the instant system is similar to an e-mail process whereby new messages that arrive are stored on the server computer until the recipient initiates the e-mail reader. Also, a DTO will continue to be stored and appear on the customer's screen until cancelled by the customer, or by the TSM when the transaction is complete or the DTO has been dormant during a preset time period.

The VP is actually a network of providers or suppliers of the goods and services which are available through the practice of the instant invention and its systems. Each vendor interested in joining this network will register with the TSM and will input therein the data and information required to allow the TSM to contact them upon the receipt of a customer request to purchase the product or service they are offering, as well as whatever is required to allow the TSM to interact and communicate with the VP participant during the conduct of the transaction. Once a CP participant initiates a request for a certain product or process with the TSM, the TSM reviews all the data and information provided to assure it is adequate to initiate a transmission to the appropriate participants in the VP, and once a positive determination is made, the TSM identifies and notifies each participant capable of supplying the necessary product or service. If the data from the CP participant is not complete, the TSM will request additional input before contacting the VP. The notification to each appropriate VP participant is accompanied by a request for an offer in response to the CP's DTO. Generally speaking, those VP participants wishing to submit a responsive offer to the DTO will transmit same to the TSM which will compile and store all said offers for transmission to the customer making the said request. The essence of the instant invention is that all members of the VP realize that their offer to the customer must be competitive with the offers of other members, based upon price, delivery or any other factors defined by the user of the CP, and they each have the opportunity during the pendency of the transaction to improve or alter their offer by submitting an amended offer to the TSM for transmission to the customer. The TSM will be able to signal such an amended offer to the customer by activating a tab on the DTO, for example a flashing light signal. Once the final offers are transmitted to the customer, a final purchase decision is made by the customer, transmitted to the TSM and then executed by the TSM with the selected participant of the VP, including the arrangement for payment by the customer and delivery by the VP provider. The TSM monitors the completion of the purchase and the transaction is closed, the DTO being extinguished.

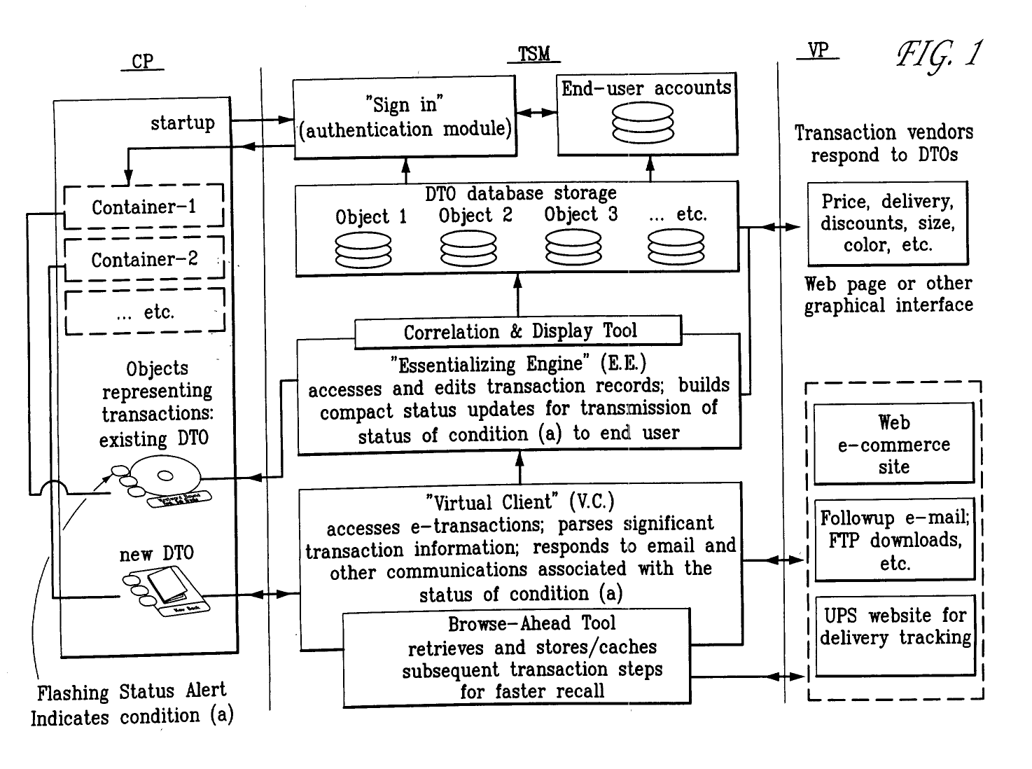

In addition to the foregoing general description of the instant invention, it is also possible to describe it graphically, as shown by the representations set forth in FIG. 1 below:

[image]

More specifically, as shown in FIG. 1, the user of the CP (the “customer”) initiates a transaction hereunder by accessing the TSM and entering his customer account identification, which is verified by the TSM and the customer goes on-line with the TSM. On the customer's screen is displayed the present status of the customer's account, including all updated DTOs relating to any pending transactions of the account, which are in the TSM's DTO Data Base. If the customer wishes to initiate a new transaction a new DTO will have to be created by interacting with the respective product icon provided on the customer's screen by the TSM, and providing the necessary information regarding the product or service being sought. The customer may also create a new DTO by “cloning” or duplicating an existing DTO and then amending or changing one or more of its properties or parameters, or by using other on-line methods, for example key word markers, such as the name of a book store when a book is the desired product.

Once a DTO is created on the customer CP and transmitted to and stored in the data bank of the TSM, the TSM compiles the data and transmits the purchase request to those participants of the VP which are part of the transactional network registered with the TSM and which have agreed to be suppliers and providers of the products and/or services which are the subject of the instant DTO. The responses of the participating VPs to the said DTO are then transmitted to the TSM which filters, essentializes and collates same for transmission to the customer's CP for review. The VP responses may be standard automated messages or customized e-messages with added materials for transmission to the CP. This feature of the system allows smaller suppliers in the VP to provide information which may be of interest to the customer, such as other related products which may be available, or other services it is able to offer the customer, as an inducement to make the purchase.

All information that the customer using the CP enters into the DTO which could identify the person, except for the customer's zip code, is kept confidential at the TSM and is not forwarded to the VPs. A means to identify geographical location however, is generally needed by the VPs to know potential sales tax and shipping information for the desired item, so that the VP can more meaningfully respond to the DTO, without the privacy of the customer ever being compromised. The geographical location data also allows the TSMs and VPs to enter into dynamic mobile transactions, for example a limousine to take the customer from one location to another. This feature of the invention permits it to fulfill the needs of mobile-e-commerce, and allows the use of handheld computing devices in the practice of the invention.

Another feature of the DTOs of this invention is the customer's ability to select, in a personal preference file, the personal or demographic information they want to divulge to the VPs as part of a DTO. In the performance of a simple e-commerce transaction, the postal code where the purchase is to be shipped would be the default, but a customer might choose to divulge some further personal information in return for some further consideration. For example, the customer may offer to divulge a list of magazines subscribed to in exchange for the responding VP offering an additional discount off the subscription price.

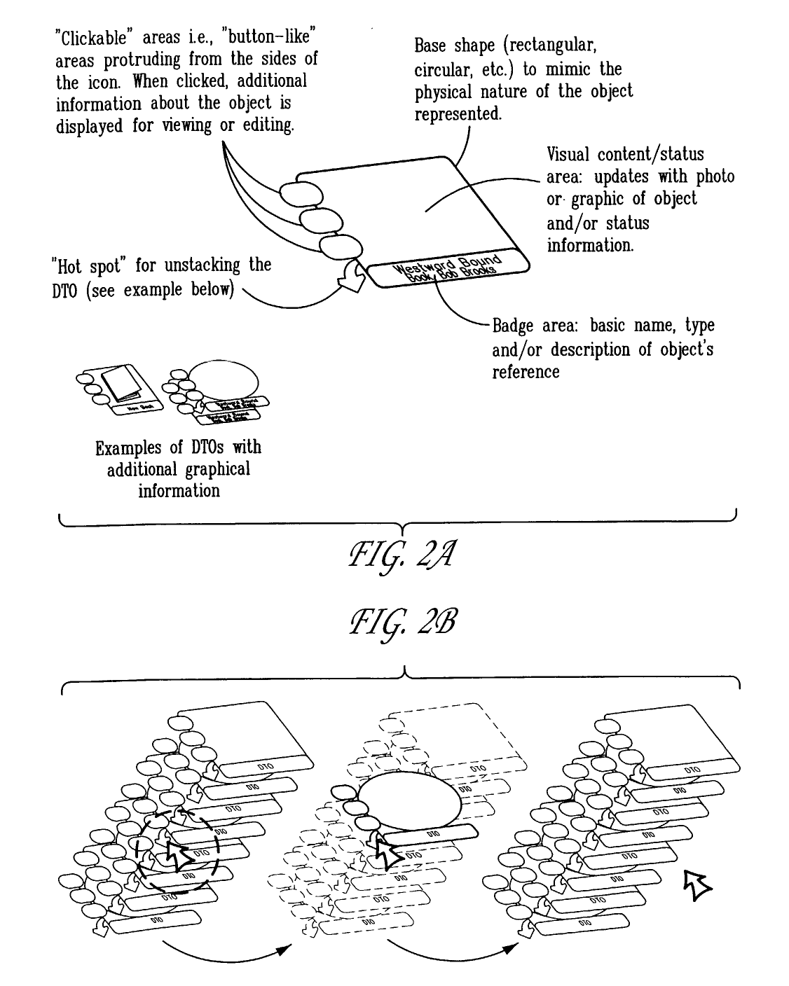

The DTO of this invention may be more clearly understood from the graphic description set forth in FIGS. 2a and 2b set forth hereinafter:

[image]

[image]

FIG. 2a provides a graphical representation of the DTO's characteristics, for example if a book were the subject of the transaction being conducted. The information and properties of the DTO are set forth in this example.

FIG. 2b exemplifies the operation of the interactive tabs or protrusions which are integral to the operation of this invention. Moving the mouse cursor over the tab on a specific DTO in the stack causes it to temporarily jump to the front of the stack, while the remaining DTOs shift out of focus to enhance the readability of the contents of the selected DTO. Moving the mouse cursor off the tab causes the DTO to return to its original place within the stack.

This invention also promotes the customer's privacy by putting the customer in control of how much or how little of their personal information is divulged before or during a transaction. In fact, the customer can offer this information to obtain better prices or other considerations. For example, the customer chooses to divulge membership in AAA when seeking to get B&B travel accommodations. In exchange for this information (and the opportunity to market to the customer's particular need) the customer may receive an additional discount being offered by a particular establishment, such as a coupon for a free breakfast. It should be noted however, that all communications between customers and suppliers are transmitted through and controlled by the TSM, under strict disclosure policy rules set by the customer, thus protecting the customer's privacy.

Once a set of VPs have responded to the TSM's request with information such as price, tax and shipping, as well as other collateral offers, e.g. a free T-shirt with first purchase, the TSM updates the DTO to reflect all such responses, and correlates the information for easy viewing by the customer. So, for example, if multiple responses are received from different VPs, showing the availability of a requested book title, when the customer activates its computer and enters the TSM website, thus downloading from the TSM data bank updates to their existing DTOs, the DTO in question graphically indicates the presence of such an update by means of an indicative portion of the DTO (e.g. through the flashing of one of its protruding tabs). The customer can then click on the flashing tab and the DTO will respond by retrieving and displaying a table correlating the VP responses by book store name, price, shipping information and any other details supplied by the respective VP, in an easy to read and understand, tabulated format for ease of comparison. This will allow local smaller vendors to compete on a level playing field with the larger nationwide VPs. In this regard, it is to be noted that a local book store can determine that it will only respond to DTOs originating within the surrounding ZIP codes, avoiding responses to inquiries from parties outside of its geographical area and who would be difficult to service.

The practice of this invention also requires the TSM to distill all steps of a transaction down those specifically required, and eliminating all the surrounding clutter which would otherwise appear on the customer's screen, including unneeded or extraneous e-mail messages. The advantages of limiting the transmitted data to that which is essential to the transaction, or “essentializing” the data, are that the customer sees only the information necessary to complete the transaction, and that the process steps of the transaction simplified to the point where they can all be represented to the customer on one screen page. An additional advantage is that the customer sees only the information necessary to meaningfully track the transaction, and in fact can choose the level of tracking desired. A still further advantage is that the customer views all transaction information in a uniform and familiar way regardless of what the VPs websites or e-transaction mechanism looks like.

In one embodiment of this invention, the transaction steps may be performed on one page on the customer's computer screen, where there are multiple sections represented by rows across the page, stacked vertically, as rows in a table. Each row is an expandable outline that represents one transaction step or a family of such steps. The customer must take the steps in order, completing the rows, from top to bottom. The bottom rows in the outline are collapsed and disabled (grayed out) until the customer has taken all necessary preceding steps. The customer takes a particular step by first activating the row representing that step, and when the customer does so, the row telescopes downward (expanding the outline and pushing all rows below it down), to show the particular choices the customer must make in order to take the step or family of steps (such as method of payment). Preferably, there is an indicator for each step showing the state that the corresponding transaction step is in (such as incomplete, complete or error). This indicator is preferably an icon of a traffic signal having red, green and yellow lights. The signal of each step may begin with the yellow light on meaning at least one choice by the customer is outstanding for that step. When a row is opened to make a choice for that step, the light will remain yellow as long as there are some choices remaining to be made and then turns green when all choices have been validly made; otherwise it turns red if at least one choice for that step has been filled in with an invalid entry. Until the light turns green, the rows below the current row remain non-functional. As the customer is taking the transaction steps, it is possible to go back to a previous step that was completed, and change the choices made for that step.

Once all the rows are filled in with acceptable values, the customer is given the ability to verify the completion of the transaction by purchasing the said product or service, by transmitting the appropriate purchase order to the TSM, which in turn, after verification, transmits same to the chosen VP, along with the requisite payment and shipment information, which is stored in the customer's account in the TSM's data bank. Once the VP acknowledges the completion of the purchase the TSM notifies the customer, and the respective DTO's visual representation on the customer's computer display screen changes to represent the transaction or purchase has been consummated.

Should the customer desire to delay the actual purchase decision, the customer may store the transaction, i.e. the DTO, for future use and may thereafter return to the stored transaction to complete it at any time.

Another aspect of the instant invention is the retention in the TSM of a database of DTOs in which records are stored recording each DTO's properties, as well as the status and history of the transaction the DTO represents. The history thereof may include records of messages sent by the VPs to the TSM regarding the transaction, including e-mails. When a DTO is first created, the TSM creates in its data banks a phantom or pseudo e-mail address dedicated solely to that particular DTO. The TSM uses this phantom address in all contacts with third parties relating to the said DTO, and all e-mails received by the TSM in response are filed and stored by the TSM in that DTO's file, for later recall.

In addition to the foregoing, in the computer systems of the TSM are two software tools, one of which operates to filter out unnecessary e-mail messages (among other extraneous things) and processes some non-excluded messages for ultimate transmission to the customer. For example, once the customer makes the purchase, the selected VP may send a message to the TSM simply confirming the purchase, which the TSM filters to a notice of confirmation of purchase to the customer, eliminating other parts of the e-mail. Another example of the filtering system is seen when the shipping entity being used by the VP to deliver the purchase sends an e-mail to the TSM with a tracking number. The TSM will strip out the tracking number and determines the appropriate website by which the shipment can be tracked for follow up on delivery status. The customer will however be advised that the purchase was shipped and the TSM will track it if necessary. These filtering steps are performed internally by the TSM which will then provide updates of the respective DTOs based thereon. For example, the TSM may be programmed to log onto the VP or its shippers website to determine the status of any specific purchase (DTO) at predetermined intervals for purposes of follow-up and notification of the customer through updated DTO. An additional software tool which may be employed by the TSM allows it to act as the alter ego of the customer, to perform all tasks for the actual customer that can be automated, thus freeing the customer from having to perform these tasks manually. For example, if the customer purchases a multiple content file, such as digitized movie, the TSM automatically navigates to the file's download page on the World Wide Web (“WWW”) where the file resides and downloads the media content file to the customer's computer.

Another aspect of the instant invention involves the TSM being able to manage the anonymous storage and retrieval of small preference files, the so-called “cookies”, on the WWW. These cookies reside on the customer's computer and are used by e-commerce websites to recall previous data received from a customer. As such they represent a security risk to the customer when used in or for subsequent unconsented transactions. The TSM manages the interaction with these cookies in a manner similar to the handling of e-mail by creating a phantom address to which they are directed and filtering them out prior to transmission to the customer. The TSM thereby keeps the cookie based information private and anonymous by avoiding the storage thereof on the customer's computer. In sum, the TSM manages, receives and sends all electronic interactions associated with the transaction, from end-to-end, thus freeing the customer from having to interact with any third party involved therein.

In the practice of this invention the customer's screen displays the DTOs in contained or holding areas, which show up as DTOs grouped together by product class or other indexing means, and the screen is scrollable both vertically and horizontally if there are too many of such stacks to show at one time. The different containers are accessed via screen interface elements (such as tabs along the top, bottom or sides, that can be clicked on with a mouse) that allow the changing of the screen's population of DTOs. In a sense this is similar to organizing the DTOs in directories or files.

When the customer selects a particular transaction step (such as choosing which vendor to purchase from, the quantity to purchase or the payment method) such decision is communicated by the software running locally on the customer's computer to the TSM. In response, the TSM determines the set of possible subsequent steps in the transaction and browses ahead on the web sites of the responding VPs to glean the information which, once filtered and compacted, will be presented to the customer for the next transaction step. The system thus exploits the natural latency period which occurs while the customer is thinking about the present decision, to allow the TSM to load the information that the customer will next be presented with when it is time for the next transaction step. Pursuant to this novel technique, when the customer chooses an item to purchase and the quantity thereof, the TSM loads in all information and pulls it into the DTO, filters and essentializes it, and when the customer opens the next step, all necessary information is present.

In the invented method, when the TSM has received responses from one or more VPs, it correlates the information and sends it to the customer side of it data storage facility to be included in the properties or the appropriate DTO on the customer's screen. When the customer receives the updated information and opens the appropriate property on the DTO, the customer software displays the filtered and compacted essentialized information from the VP in an easy to understand tabular format. This process acts as an equalizing means so as to put all VPs on the same footing on the customer's video display. The offerings from all VP responders are displayed side by side, with not only the price, but the customized offering from each VP displayed. It therefore allows the customer to make a correlated judgment of the value of a proposed transaction based on any parameter defined for it, not limited to price or availability.

The communications protocol between the customer software running on the customer's computing device and the TSM software is more streamlined and efficient than the typical hypertext transfer protocol (“http”) used to interact with the internet. The TSM must use the http to go to the web sites of the VPs and other parties involved in the transaction, as that is the protocol supported by such sites. However, the TSM then filters and essentializes such information, and can use more compact and efficient proprietary protocol to update the DTOs on the customer's computer. This achieves efficiency in two ways. First all extraneous material, such as advertising copy and other html that would appear on a web browser display are filtered out by the TSM's essentializing process. Secondly, the protocol is customized and proprietary to the invention to be highly optimized for compactness and abbreviation of the data so that status updates between the TSM and the CP are fast even over low-band width connections used, such as modems, wireless, cellular and other devices which connect to the internet or other networks. This data optimization is similar to compression algorithms used by such commercial file compression products such as WinZip(TM).

Another of the novel aspects of the instant invention includes the presentation to the customer of a DTO in a graphic form that is suggestive of the product that is the subject of the proposed transaction. For example, a transaction in which a customer is seeking to purchase a compact disc is represented by an icon of a compact disc. Furthermore, the method is novel in that the DTO represented to the customer is dynamic, and changes in response to the forward motion (or status) of the complex transaction which it represents. The above referenced protruding properties or tabs on the DTO icons are actually indicative portions that change dynamically in accordance with the status or condition of a transaction. For example, suppose the customer creates a transaction for the purchase of a book. The customer can set the DTO's set of properties such that it has a “book reviews” property or tab. The customer can set this property or tab to begin flashing when there are a predetermined number, such as six, new on-line reviews of the identified book. The TSM will detect such a property, and at various predetermined intervals, check to see the number of book reviews available. When the predetermined number are available it will notify the customer by flashing the appropriate tab. This is one example of the configurability and flexibility of the DTOs of this invention. Another novel aspect of the invented method comprises the stackability of the DTOs with the ability to review dynamic portions of the DTOs that are not at the top of the stack. This is accomplished as noted hereinabove by the fact that the DTOs are displayed in isometric fashion with protruding property or tab indicators.

In the practice of this invention, in addition to creating a DTO from scratch, it can be created by “cloning” an existing DTO. Once cloned, the properties or tabs can be edited, such that the customer now has a different DTO representing a different transaction. Additionally, after a transaction has been completed, and a DTO has expired (i.e. there are no more activities to be taken by any party and the transaction is completed), the customer can resurrect the expired DTO with new properties or tabs so that it now represents a different transaction. In this event, the TSM will create a new phantom e-address and or related cookie information for it, even though physically it appears to be the same DTO, albeit containing different properties. Other less conventional means of DTO creation can be used as well. For example, a bar code scanner can be integrated into the customer data side of the TSM system. The customer could use it to scan the bar code of a product and the customer software would respond through the TSM by creating a corresponding DTO. Such DTO would create a transaction in which the TSM polls VPs for information about competing prices, etc. of the said product or similar products.

In addition, in the further practice of the invention, DTOs can be repeating in the sense that they do not represent one transaction only, but an ongoing series of transactions. The customer can specify that each repeating DTO present a confirmation dialog (e,g, an on-screen message with clickable Yes and No buttons) to authorize successive uses of the DTO, to avoid unwanted repeat transactions. For example a customer that wishes to purchase copier paper at monthly intervals can create a repeating DTO that is programmed to place an order for such paper once a month.

A further practice of the invention is to use the DTOs to represent conversations and dialogs between private individuals, in which scenario the DTO's graphical representation is of the individuals engaging in these conversations. This in turn creates a private network of communication “channels” between such parties through the TSM, that is an adjunct or replacement for conventional electronic mail. In addition, the DTOs may be used to monitor details and status relating to transactions conducted outside the system, such as tracking a shipped package, or the arrival or departure of a common carrier, or any event, price, schedule, or availability of interest, thus making the DTO a pure status-display object. A DTO can also be created on the customer's behalf with his permission, to keep track of a vendor's or other party's performance in conjunction with the transaction being performed.

The foregoing description and examples demonstrate the operation of the instant invention, however the worker skilled in the art will understand that various modifications and other embodiments of this invention are possible without departing from the scope and ambit of the instant invention as described in the claims appended hereto.

What is claimed is:

1. An interactive dynamic continuous system for the purchasing and selling products and services electronically on-line, which comprises:
a. A Customer Platform comprised of a customer operated computing device capable of intiating and completing the multistep process of transactions required to effect the purchase of products or services on-line; and
b. A Vendor Platform comprised of a network of potential vendors of said products and services demanded by the Customer Platform and consisting of a responsive electronic computer network capable of responding on-line to supply the products and services to the Customer Platform; and
c. A Transfer Service Means which is capable of conducting dynamic, interactive electronic communication between said Customer Platform and Vendor Platform to effectuate and complete the purchase sought to be made by said Customer Platform.

2. The system of claim 1, which utilizes a dynamic transaction object for purposes of initiating, modifying, monitoring and completing said online purchase transaction, and which comprises a multifunctional graphic icon created on the Customer Platform computer screen and which is capable of receiving, storing and displaying data received from the Transfer Service Means, and having incorporated thereon a number of discrete interactive areas capable of being viewed or activated by means of the Customer Platform in order to monitor or execute the various steps comprising the said online transaction.

3. The dynamic transaction object of claim 2.
